(19) United States
(12) Patent Application Publication
(10) Pub. No.: US 2003/0053261 A1
(43) Pub. Date: Mar. 20, 2003

(54) Bandwidth disc drive actuator

(76) Inventors: Terang KongBeng Thia, Singapore (SG); Joseph HengTung Lau, Singapore (SG); Andre YewLoon Liem, Singapore (SG)

Correspondence Address: Derek J. Berger, Seagate Technology LLC, Intellectual Property - COL2LGL, 389 Disc Drive, Longmont, CO, 80503, US

(21) Appl. No.: 10/126,725

(22) Filed: Apr. 18, 2002

Related U.S. Application Data
(60) Provisional application No. 60/322,419, filed on Sep. 14, 2001.

(51) Int. Cl. G11B 5/55

(52) U.S. Cl. 360/266

(57) ABSTRACT

A disc drive with improved servo-mechanical frequency response includes a rotary actuator assembly incorporating stiffening members disposed along the sides of its actuator arms. In one embodiment the stiffening members comprises edge rails. The edge rails may rise from only the upper surface of the actuator arm or from both the upper and lower surfaces. In one embodiment the stiffening members comprise wings which project upward from the sides of the actuator arm.

### CROSS-REFERENCE TO RELATED APPLICATION

This patent application claims priority from U.S. Provisional Application No. 60/322,419 filed on Sep. 14, 2001.

### FIELD OF THE INVENTION

The present invention relates to data storage devices. More specifically, but not by way of limitation, the present invention concerns actuators for accessing data in hard disc drives.

### BACKGROUND OF THE INVENTION

Until recently, the width (radial direction) to length (circumferential) direction aspect ratio of a group of magnetic particles storing one bit of data in hard disc drives has typically been about 15-to-1. In recent years, in order to increase data storage capacities, designers have decreased bit width so that more tracks can be squeezed onto the disc surface. However, an increase in track density requires a corresponding increase in overall servo-mechanical performance. Furthermore, as track width decreases the effect of external disturbances such as spindle vibrations and disc flutter and wobble becomes more significant. Off-track head displacement induced by such disturbances is significant relative to the narrow inter-track spacing.

A disc drive servo system's susceptibility to spindle vibration and associated low frequency disturbances may be reduced by increasing the servo-system's bandwidth. However, in general the servo system bandwidth frequency is limited to about 20% of the lowest mechanical resonance frequency of the actuator assembly.

An actuator system has four primary bending modes, each having a resonant frequency a designer must be concerned with. One such bending mode, conventionally known as a “first bending mode,” involves bending of the actuator arm out of the rotational plane of the actuator, where the bending takes place near the pivot cartridge. Another bending mode, conventionally known as a “second bending mode,” similarly involves bending out of the rotational plane of the actuator, but where the bending takes place further away from the pivot axis, near the flexure support end of the actuator arm. A third bending mode is the “first torsion mode,” in which the actuator arm twists about a longitudinal axis of the actuator arm, such that the plane of the actuator intersects but is no longer parallel to the rotational plane of the actuator. A fourth primary bending mode is the “first sway mode,” in which the actuator arm bends within the rotational plane of the actuator. A further limiting mechanical resonance frequency is due to vibration in the so-called “butterfly” mode. In the butterfly mode the read/write head end of the actuator arms and the fantails swing simultaneously to left and right relative to pivot assembly in the manner of a butterfly's wings flapping about its body. The butterfly mode resonant frequency is determined by the sway modes of the coil structure and arm structure and limited by the lower of these frequencies. As the servo system directs the actuator to move the head from track to track, the actuator will vibrate in these various modes. As long as the frequencies generated by the servo system remain below the various resonant frequencies of the actuator, the drive will continue to function properly. It should be clear that the speed at which the drive may operate is limited by the resonant frequencies of the actuator system. It is generally a goal of actuator design, therefore, to raise the natural resonant frequencies of the actuator system to allow for faster drive operation.

One approach to increasing the resonance frequency of actuator arms has been to increase the mechanical resonant frequency by making the actuator arms out of stiffer and lighter materials. However that approach entails using materials which may be expensive and/or difficult to work with.

Another approach to providing a servo system with improved frequency response characteristics has been the use of a secondary microactuator. Here, a first coarse servo system is used to move the actuator head across large distances and a second lighter servo system effects movement in a smaller microactuator to handle fine seek requests. However, microactuators at his point in time are expensive and much more research and development will be necessary before they can be effectively implemented in hard disc drives.

What the prior art has been lacking is a low-cost method for improving servo system frequency response characteristics without significantly increasing costs associated with materials and/or manufacturing, and is easily fabricated using standard technologies.

### BRIEF SUMMARY OF THE INVENTION

According to one embodiment of the present invention there is provided a stamped actuator arm for a disc drive of the type incorporating a rotary actuator assembly, the actuator arm including one or more stiffening members arranged to increase said arm's resistance to lateral bending. These stiffening members may take the form of two raised stiffening rails located along opposing long edges of the arm.

Additional features and benefits will become apparent upon a review of the attached figures and the accompanying description.

### BRIEF DESCRIPTION OF THE DRAWINGS

FIG. 1 is a stylized top view of a hard disc drive incorporating an actuator of the present invention.

FIG. 2 is an isometric view of a typical stamped actuator arm.

FIG. 3 is an isometric view of an actuator arm according to an embodiment of the present invention.

FIG. 4 is an isometric view of an actuator arm according to a further embodiment of the present invention.

FIG. 5 is an isometric view of an intermediate stage in the production of the actuator arm of FIG. 6.

FIG. 6 is an isometric view of an actuator arm according to a further embodiment of the present invention.

### DETAILED DESCRIPTION OF THE INVENTION

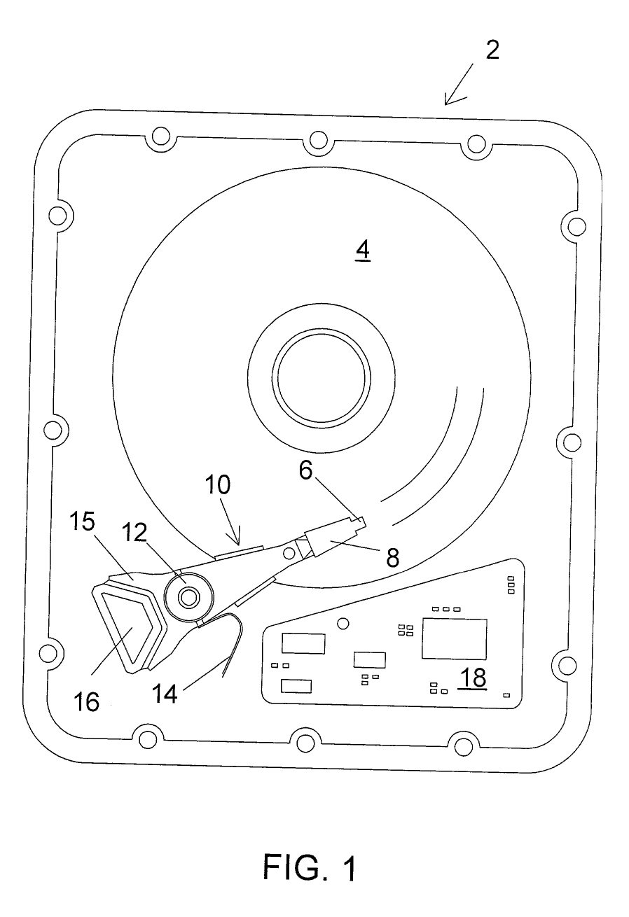

FIG. 1 is a stylized top view of a hard disc drive 2 with cover removed to reveal its inner workings. The disc drive includes a stack of magnetic platters 4 of which only the uppermost is visible. Each platter takes the form of a rotatable storage disc operatively rotated at a constant speed of several thousand RPM by a spindle motor (not shown). Each platter 4 typically comprises a disc substrate having a surface on which a magnetic material is deposited. Digital data is stored on the disc as a series of variations in magnetic orientation of the disc's magnetic material. The variations in magnetic orientation, generally comprising reversals of magnetic flux, represent binary digits of ones and zeroes that in turn represent data.

Data is written to and read from concentric tracks on each magnetic platter 4 by each of a number of read/write head assemblies or sliders 6 of which the uppermost one is visible. Each read/write head assembly 6 includes a magnetoresistive (MR) head unit supported by a corresponding suspension assembly 8. Each slider 6 glides over the surface of a corresponding one of the platters 4. Each slider 6 is coupled to a corresponding actuator arm 10 via a suspension 8 which rotates about pivot assembly 12. The actuator arms 10 are stacked one above the other to form a rotary actuator assembly. Actuator arms 10 may be formed by stamping them out of a flat plate of aluminum.

Each actuator arm 10 has a rear “fan-tail” portion 15 into which a voice coil 16 is mounted. Attached to the actuator arm assembly is a printed circuit cable (PCC) 14 which serves to transmit electrical signals to and from read/write and servo system circuitry mounted on printed circuit board (PCB) 18.

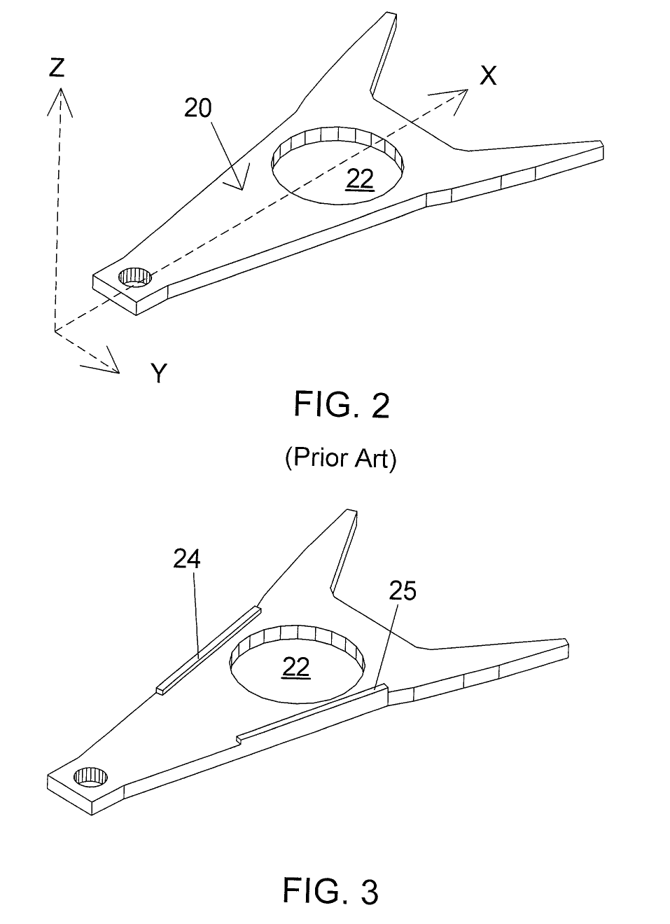

FIG. 2 shows an actuator arm 10 as typically used in a hard disc drive 2. The arm 10 may be formed by stamping it out from a metallic plate. Aluminum has been found to be satisfactory material of manufacture, primarily because of its low inertia, low cost and ease of manufacture. However, it is contemplated that any number of materials could be used without departing from the spirit of the invention. This arm 10 may be used alone, as a single-stage actuator carrying a single suspension 8 and head 6 for accessing a single side of a disc 4. Alternatively, an arm similar to the one shown in FIG. 2 may be produced without the coil support portion 15. In this instance, a number of arms may be vertically aligned and “stacked” atop one another. A single coil support portion 15 is then provided, and an overmold is provided uniting the arms 10 and coil support 15 together in a single unit. Commonly known as a stacked actuator, this type of actuator may be provided with a large number of suspensions 8 and heads 6 (typically two heads 6 to each arm 10) for accessing a larger number of discs 4.

Where a stamped, monolithic actuator arm 10 such as the one illustrated in FIG. 2 is used, the bending resistance of the actuator arm in the lateral Y-axis direction (i.e. the off-track direction) is often found to be undesirably low. This is due at least in part to a lack of material, especially about the circular hole 22 formed to receive a disc drive's pivot assembly. It is believed that the low bending resistance in the Y-axis direction is also a contributing factor to the actuator having a low butterfly mode resonance frequency. Bending resistance in the Z direction, transverse to the surface of the disc 4, is also a problem with actuator arms, particularly with a stamped arm such as the one illustrated in FIG. 2. Again, pivot hole 22 is one cause of this. Bending in this way is commonly called the “first bending mode.”

An actuator arm 10 according to a first embodiment of the present invention is shown in FIG. 3. It will be noted that the actuator has been formed with raised stiffening members in the form of rails 24 and 25 located along opposite edges of the upper surface 26 of the actuator arm and adjacent pivot assembly hole 22. The inventors have found that addition of the rails increases the elastic section modulus, S, of the actuator since:

S=I/c

where I is the second moment of inertia of the area, and c is the centroid of the cross section.

Provision of the rails thus confers a resistance to lateral and transverse, vertical bending without substantially adding to the weight of the actuator which would be undesirable.

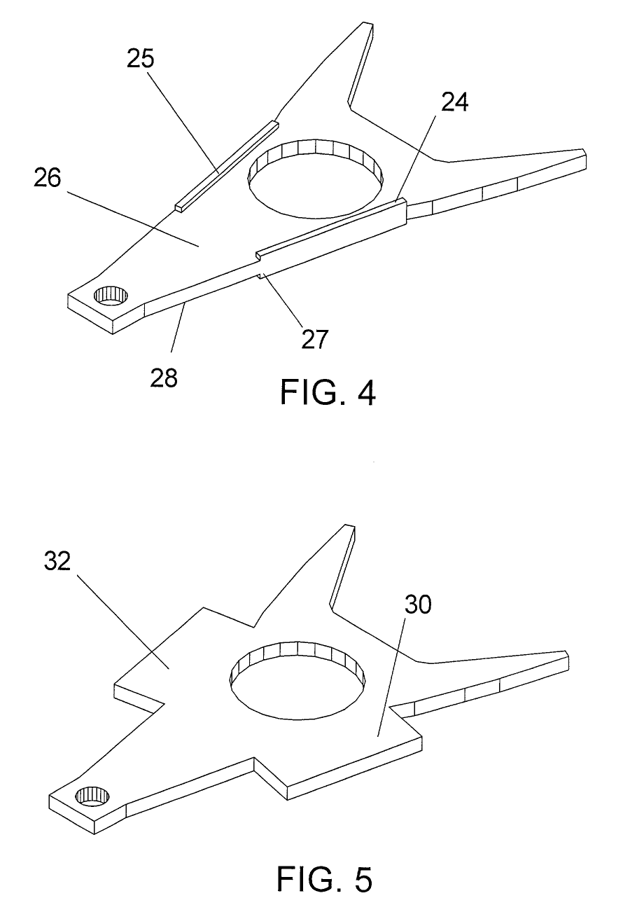

FIG. 4 depicts a further embodiment of the present invention wherein rails 24, 25 and 27 (a fourth rail protruding from the underside 28 beneath rail 25 is not visible) are located both on the upper surface 26 and lower surface 28 of the actuator. The addition of the extra rails on the underside of the actuator arm further increases the arm's resistance to lateral bending and so increases the mechanical resonance frequency of the arm.

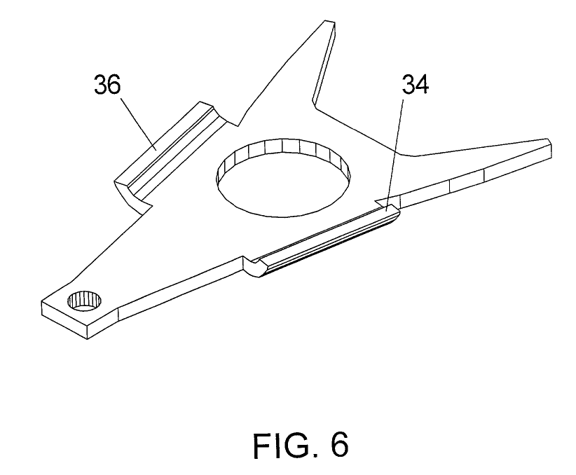

Yet another embodiment of the present invention is illustrated in FIG. 6. The embodiment of FIG. 6 is formed by firstly stamping out an actuator of the shape shown in FIG. 5 with lateral wings 30 and 32 in a single piece and then folding or bending up the wings to form stiffening members in the form of rails 34 and 36 of FIG. 6. One of ordinary skill in the art would recognize that the stamping and bending steps may be performed in a single step by appropriately configuring the die used to perform the stamping operation.

In each of the embodiments shown in FIGS. 3, 4 and 6 the presence of the rails increases the arms' stiffness and thereby significantly increases the butterfly mode resonance frequency. The inventors have tested the embodiment of FIG. 3 with a rail height of 1.5 mm (60 mils) above the upper surface of the arm and found that the resonant frequency is increased by 200 Hz over that of a prior art actuator arm of the type shown in FIG. 1.

It should be understood that the configuration of the rails 24,25,26,27,34, 36 may be “tuned” so as to vary the resonance characteristics of an actuator arm 10. For example, lengthening rails along the longitudinal extent of the arm 10 would increase the stiffness of the arm with respect to lateral bending, and would increase resistance to transverse bending along the extent of the rails. Similarly, changing the height of the rails significantly increases the resistance to transverse bending while also contributing to an increase in resistance to lateral bending. The precise shape of the rails may also be modified so as to tune the stiffness of the actuator arm with respect to its various bending modes and resonant frequencies.

Accordingly, a hard disc drive incorporating at least one actuator arm according to the present invention may be operated with a larger servo system bandwidth than would be the case if prior art actuator arms were used. Consequently finer control of read/write head position may be achieved and narrower inter-track spacings used.

It is to be understood that ever though numerous characteristics and advantages of various embodiments of the present invention have been set forth in the foregoing description, together with details of the structure and function of various embodiments of the invention, this disclosure is illustratively only, and changes may be made in detail, especially in matters of structure and arrangement of parts within the principles of the present invention to the fill extent indicated by the broad general meaning of the terms in which the appended claims are expressed. For example in the embodiments thus far described the rails have been contiguous with the actuator arm along their length, however, the rails might instead be fixed only at each end to the actuator arm. Furthermore, they may be of different cross section to those described. In addition, although the present invention has been described with reference to preferred embodiments, it will be appreciated by those skilled in the art that the teaching of the present invention can be applied to other systems without departing from the scope and spirit of the present invention.

We claim:

1. An actuator for use in a disc drive, the actuator comprising:
a generally planar, longitudinally extending arm formed from sheet material, the arm comprising:
first and second edges extending along the longitudinal extent of the arm;
an aperture configured to receive a pivot assembly; and
a first stiffening member extending along the first edge, the stiffening member protruding out of the plane of the arm.

2. An actuator according to claim 1, further comprising:
a second stiffening member extending along the second edge.

3. An actuator according to claim 1, in which the first stiffening member is integrally formed with the arm.

4. An actuator according to claim 1, in which the first stiffening member comprises a wing of sheet material, the wing having a proximal end mounted to the first edge and a distal end positioned out of the plane of the arm.

5. An actuator according to claim 4, in which the sheet material wing comprises a bent portion.

6. An actuator according to claim 4, in which the wing is integrally formed with the arm.

7. An actuator according to claim 2, in which at least a portion of the pivot aperture is positioned between the first and second stiffening members.

8. An actuator according to claim 2, in which a majority of the pivot aperture is positioned between the first and second stiffening members.

9. An actuator according to claim 1, in which the arm and the first stiffening member are formed by a single stamping operation.

10. A disc drive comprising:
a base; and
an actuator rotatably mounted to the base, the actuator comprising:
a longitudinally extending, generally planar arm comprising:
first and second edges extending along the longitudinal extent of the arm; and
a first stiffening member extending along the first edge, the stiffening member protruding out of the plane of the arm and comprising sheet material including a bent portion.

11. A disc drive according to claim 10, in which the arm and the first stiffening member are integrally formed.

12. A disc drive according to claim 10, further comprising:
a coil, the actuator arm including a coil support portion to which the coil is mounted.

13. A disc drive according to claim 10, in which the arm further comprises:
a second stiffening member extending along the second edge.

14. A disc drive according to claim 13, further comprising:
a pivot assembly rotatably mounting the actuator to the base, at least a portion of the pivot assembly being located between the first and second stiffening members.

15. A disc drive according to claim 10, in which the arm is formed from sheet material.

16. A disc drive comprising:
a base;
an actuator rotatably mounted to the base, the actuator being formed from sheet material and comprising an actuator arm; and
means for stiffening of the actuator arm.

17. A disc drive according to claim 16 in which the stiffening means comprises stiffening members attached to the actuator arm.

18. A disc drive according to claim 16 in which the actuator arm comprises a pivot aperture, and in which the stiffening means comprises edge rails disposed adjacent the pivot aperture.
